(19) United States
(12) Patent Application Publication
(10) Pub. No.: US 2013/0029183 A1
(43) Pub. Date: Jan. 31, 2013

(54) CARBON BLACK COMPOSITION AND USAGE THEREOF

(71) Applicant: Kazufumi OMURA, Minami-ashigara-shi (JP)

(72) Inventor: Kazufumi OMURA, Minami-ashigara-shi (JP)

(73) Assignee: FUJIFILM Corporation, Tokyo (JP)

(21) Appl. No.: 13/560,569

(22) Filed: Jul. 27, 2012

(30) Foreign Application Priority Data
Jul. 29, 2011 (JP) 2011-166407
Jun. 28, 2012 (JP) 2012-145057

(51) Int. Cl. C08K 5/17; G11B 5/70; C09D 5/00; C08L 75/04; C08L 27/06

(52) U.S. Cl. 428/844.8; 106/476; 524/251; 428/842; 428/844.5

(57) ABSTRACT

An aspect of the present invention relates to a carbon black composition, which comprises carbon black; an organic tertiary amine selected from the group consisting of an aliphatic tertiary monoamine and an alicyclic tertiary amine; and at least one organic solvent selected from the group consisting of methyl ethyl ketone, cyclohexanone, isophorone, and ethanol.

### CROSS-REFERENCE TO RELATED APPLICATIONS

This application claims the benefit of priority under 35 USC 119 to Japanese Patent Application No. 2011-166407 filed on Jul. 29, 2011 and Japanese Patent Application No. 2012-145057 filed on Jun. 28, 2012, which are expressly incorporated herein by reference in their entirety.

### BACKGROUND OF THE INVENTION

1. Field of the Invention

The present invention relates to a carbon black composition, and more particularly, to a carbon black composition capable of achieving a highly dispersed state of carbon black in solvent.

The present invention further relates to a carbon black-containing coating film obtained from the above carbon black composition and a magnetic recording medium comprising the above coating film.

2. Discussion of the Background

Carbon black is employed as a coloring material, electrically conductive material, filler and the like in various fields such as print ink, paints, cosmetics, and batteries. In the field of magnetic recording, carbon black is widely added to magnetic layers, nonmagnetic layers, backcoat layers, and the like to prevent static electricity, reduce the coefficient of friction, impart a light-blocking property, enhance film strength, and the like in magnetic tapes and disks.

As set forth above, carbon black is a useful material that is employed in various fields. However, it forms a high-order structure, known as a “structure,” that has an aggregating property in solvent. The more minute the particles, the more pronounced the above property becomes, entailing various problems. For example, in particulate magnetic recording media, when carbon black aggregates in the coating liquid, the smoothness of the coatings of magnetic layers and the like that are formed by coating and drying the coating liquid on a support is greatly compromised. When carbon black aggregates in a print ink, color irregularities and degradation of color tone result.

Thus, various attempts have been made to enhance the dispersion of carbon black in solvents. For example, in the field of magnetic recording, the use of various aromatic compounds as dispersing agents to increase the dispersion of carbon black has been proposed (for example, see Japanese Patent No. 4149648 or English language family members US2002/064687A1 and U.S. Pat. No. 6,653,000, Japanese Unexamined Patent Publication (KOKAI) No. 2002-140813, Japanese Unexamined Patent Publication (KOKAI) No. 2003-168208, Japanese Unexamined Patent Publication (KOKAI) No. 2005-222630, Japanese Unexamined Patent Publication (KOKAI) No. 2005-222631, Japanese Unexamined Patent Publication (KOKAI) No. 2006-185525, Japanese Unexamined Patent Publication (KOKAI) No. 2006-185526, Japanese Unexamined Patent Publication (KOKAI) No. 2009-224009, and Japanese Patent No. 2602273, which are expressly incorporated herein by reference in their entirety.

As set forth above, carbon black is widely employed in various fields, and there is constant demand for enhanced dispersion (aggregation prevention). However, it has the special property of forming a structure. Thus, it is not easy to enhance the dispersion of carbon black. The dispersed state of carbon black that is achieved by conventional methods—in the field of magnetic recording, for example, where a high degree of coating smoothness is demanded to achieve higher density recording—is not necessarily adequate.

### SUMMARY OF THE INVENTION

An aspect of the present invention provides for a composition (carbon black composition) in which carbon black is highly dispersed in a solvent.

To obtain the above composition, the present inventor conducted extensive research. As a result, he discovered that in a system containing an organic tertiary amine selected from the group consisting of an aliphatic tertiary monoamine and an alicyclic tertiary amine and a specified ketone or alcohol solvent, specifically, a solvent selected from the group consisting of methyl ethyl ketone, cyclohexanone, isophorone, and ethanol, the dispersion of carbon black was greatly enhanced. The present inventor presumed the following in that regard.

With regard to carbon black, the fact that a hydrophilic moiety comprising a hydroxyl group or a carboxyl group and a hydrophobic moiety comprising carbon are present on the surface of carbon black, and the fact that the hydrophobic moiety comprising carbon is an aromatic ring comprising a graphite structure are known (for example, see Adhesive Technology, Vol. 30, No. 4 (2011), Vol. 101, p. 5, FIG. 1.7). It is thought that the dispersion of carbon black is enhanced by covering the hydrophilic moiety or the hydrophobic moiety with a compound having a unit with affinity for either the hydrophilic moiety or the hydrophobic moiety. However, carbon black ends up forming a structure in solvent before the hydrophilic moiety or hydrophobic moiety is covered, so that even when a compound having a unit with affinity for either of the moieties is added, it tends not to enhance dispersion by blocking the formation of the structure.

By contrast, by employing in combination a solvent selected from the group consisting of methyl ethyl ketone, cyclohexanone, isophorone, and ethanol, which are solvents in which carbon black tends not to form a structure, and the above organic tertiary amine having affinity with the hydrophilic moiety in the above system discovered by the present inventor, it is thought that the organic tertiary amine covers the hydrophilic moiety of the carbon black surface, blocking the formation of the structure. The present inventor further presumed that as a result, it was possible to obtain a carbon black composition in which carbon black was highly dispersed.

The present invention was devised on the basis of the above knowledge.

An aspect of the present invention relates to a carbon black composition, which comprises:

carbon black;

an organic tertiary amine selected from the group consisting of an aliphatic tertiary monoamine and an alicyclic tertiary amine; and

at least one organic solvent selected from the group consisting of methyl ethyl ketone, cyclohexanone, isophorone, and ethanol.

In an embodiment, the aliphatic tertiary monoamine is denoted by general formula (1):

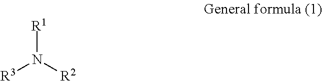

wherein each of R¹, R², and R³ independently denotes a linear or branched alkyl group having 1 to 18 carbon atoms.

In an embodiment, in general formula (1), each of R¹, R², and R³ independently denotes a linear or branched alkyl group having 1 to 8 carbon atoms.

In an embodiment, the organic solvent comprises methyl ethyl ketone and/or cyclohexanone.

In an embodiment, the organic solvent comprises ethanol.

In an embodiment, the organic solvent comprises isophorone.

In an embodiment, the carbon black composition comprises the carbon black in a dispersed state with a particle diameter in liquid as measured by a dynamic light scattering method of equal to or less than 70 nm with comprising no binder resin.

In an embodiment, the carbon black composition further comprises a binder resin.

In an embodiment, the binder resin is selected from the group consisting of a copolymer and a polyurethane resin.

In an embodiment, the carbon black composition comprises the carbon black in a dispersed state with a particle diameter in liquid as measured by a dynamic light scattering method of equal to or less than 50 nm with the binder resin.

In an embodiment, the carbon black composition is employed as a coating composition for forming a magnetic recording medium, for example, for forming a nonmagnetic layer or a backcoat layer of a magnetic recording medium or employed for preparation thereof.

A further aspect of the present invention relates to a carbon black-containing coating film, which has been obtained by drying the above carbon black composition

A still further aspect of the present invention relates to a magnetic recording medium comprising a magnetic layer containing a ferromagnetic powder and a binder on a nonmagnetic support, which comprises the above carbon black-containing coating film.

In an embodiment, the carbon black-containing coating film is a nonmagnetic layer positioned between the nonmagnetic support and the magnetic layer.

In an embodiment, the carbon black-containing coating film is a backcoat layer positioned on a surface of the nonmagnetic support opposite from a surface on which the magnetic layer is positioned.

The present invention can provide a carbon black composition in which carbon black is highly dispersed in solvent. The carbon black composition of the present invention is useful in coating liquids for particulate magnetic recording media, print inks, and the like.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The carbon black composition of the present invention comprises carbon black; an organic tertiary amine selected from the group consisting of an aliphatic tertiary amine and an alicyclic tertiary amine; and at least one organic solvent selected from the group consisting of methyl ethyl ketone, cyclohexanone, isophorone, and ethanol.

As set forth above, the present inventor presumed that by causing carbon black and the organic tertiary amine to both be present in the above organic solvent in which structures tend not to form, the organic tertiary amine covered the hydrophilic portion of the carbon black, thereby achieving a state of high carbon black dispersion.

The carbon black composition of the present invention will be described in greater detail below.

No aromatic group is directly bonded to the nitrogen atom in either aliphatic tertiary monoamines or alicyclic tertiary amines. In the present invention, such an organic tertiary amine is employed because in tertiary amines in which an aromatic group is directly substituted onto the nitrogen atom, it is difficult to increase the degree of dispersion of the carbon black even when the above organic solvent is also employed. That is because tertiary amines in which an aromatic group is directly substituted onto the nitrogen atom are presumed to exhibit a poor ability to selectively adsorb to hydrophilic portions on the surface of the carbon black.

It is desirable to employ, as the aliphatic tertiary monoamine, the aliphatic tertiary monoamine denoted by general formula (1) below to further increase the dispersion of carbon black.

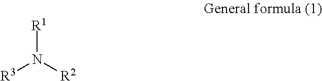

In general formula (1), each of R¹, R², and R³ independently denotes a linear or branched alkyl group having 1 to 18 carbon atoms. The alkyl group can be unsubstituted, or can have substituents. Examples of substituents are alkyl groups (such as alkyl groups having 1 to 6 carbon atoms), hydroxyl groups, alkoxyl groups (such as alkoxyl groups having 1 to 6 carbon atoms), halogen atoms (such as fluorine atoms, chlorine atoms, and bromine atoms), and aryl groups (such as phenyl groups). The “number of carbon atoms” when a substituent is present means the number of carbon atoms of the portion excluding the substituent. In the present invention, the range indicator “to” indicates an inclusive range from the preceding minimum value to the succeeding maximum value. In general formula (1), R¹, R², and R³ may all be of the same structure, or may be different. As set forth above, tertiary amines in which an aromatic group is directly substituted onto the nitrogen atom are presumed to have poor ability to selectively adsorb to hydrophilic portions on the surface of the carbon black. It is conceivable that the adsorption of aromatic groups to hydrophobic portions of carbon black hinders the amine portions from covering the hydrophilic portions. When an aromatic group is incorporated as a substituent of an alkyl group, the aromatic group is linked to the amine through an alkylene group. By using an intermediate alkylene group, the amine portion can be free to rotate. Thus, it is thought that even if the aromatic group adsorbs to the hydrophobic portion of the carbon black, the amine group is not hindered by it and can adsorb to the hydrophilic portion. That is presumed to be because an aliphatic tertiary monoamine containing an aromatic group as a substituent on the alkyl group, in combination with a prescribed solvent, can achieve a state of high carbon black dispersion.

The number of carbon atoms of the alkyl group falls within a range of 1 to 18, desirably within a range of 1 to 10, and preferably within a range of 1 to 8. The above range is desirable because it permits carbon black to be dispersed to a higher degree in the above solvent. The alkyl group can be linear or branched.

The aliphatic ring contained in the above alicyclic tertiary amine can be a saturated or unsaturated, monocyclic, bridged, or condensed aliphatic ring. The aliphatic ring is desirably a four to eight-membered ring, preferably a five to seven-membered ring, to further enhance carbon black dispersion. Alicyclic tertiary amines in which multiple nitrogen atoms form an amidine structure within the ring are desirable in that they further enhance the dispersion effect. It is thought that basicity is intensified by the presence of an amidine structure.

Specific desirable examples of the above-described organic tertiary amine are the various organic tertiary amines employed in Examples set forth further below.

The carbon black that is contained in the carbon black composition of the present invention is not specifically limited. It can be selected for use based on the application from among various carbon blacks such as furnace black for rubber, thermal for rubber, black for coloring, electrically conductive carbon black, acetylene black. With regard to carbon black suitable for use in the present invention, reference can be made to the Carbon Black Handbook (compiled by the Carbon Black Association, which is expressly incorporated herein by reference in its entirety, for example.

For example, in a particulate magnetic recording medium, carbon black can be mixed into the nonmagnetic layer to achieve the known effect of reducing surface resistivity Rs and optical transmittance, and achieving a desired micro-Vicker's hardness. A lubricant stockpiling effect can also be achieved by incorporating carbon black into the nonmagnetic layer. The specific surface area of the carbon black that is employed in the nonmagnetic layer is normally 50 to 500 m²/g, desirably 70 to 400 m²/g, and the DBP oil absorption capacity is normally 20 to 400 mL/100 g, desirably 30 to 400 mL/100 g. The average primary particle diameter of the carbon black that is employed in the nonmagnetic layer is normally 5 to 80 nm, desirably 10 to 50 nm, and preferably, 10 to 40 nm.

The surface resistance and light transmittance of the backcoat layer can be set low by adding microparticulate carbon black to the backcoat layer of a particulate magnetic recording medium. Since many magnetic recording devices utilize the light transmittance of the tape for an operating signal, adding microparticulate carbon black is particularly effective in such cases. In the microparticulate carbon black that is employed in the backcoat layer, it is desirable for the average primary particle diameter to fall within a range of 5 to 30 nm, the specific surface area to fall within a range of 60 to 800 m²/g, the DBP oil absorption capacity to fall within a range of 50 to 130 mL/100 g, and the pH to fall within a range of 2 to 11.

Reference can be made to paragraphs [0033] to [0053] of Japanese Patent No. 4149648, for example, for details on the above carbon blacks. Reference can also be made to paragraph [0067] of Japanese Patent No. 4149648 for details on the carbon black contained in the magnetic layer.

The carbon black composition of the present invention can be employed as a coating composition for forming a particulate magnetic recording medium, or to prepare such a coating composition, by incorporating various optionally added components with the above carbon black. For example, by using the carbon black composition of the present invention as a coating composition for forming the nonmagnetic layer or backcoat layer of a particulate magnetic recording medium, or to prepare such a coating composition, it is possible to obtain a particulate magnetic recording medium having a nonmagnetic layer or backcoat layer in which carbon black is highly dispersed.

The above carbon black is also suitable for use as a pigment in print ink. The carbon black composition of the present invention containing such carbon black can be suitably employed as a black ink in various types of printing such as ink-jet printing, offset printing, and gravure printing.

From the perspective of further enhancing the dispersion of carbon black, the organic tertiary amine is desirably employed in a proportion of 1 to 50 weight parts, preferably 1 to 20 weight parts, per 100 weight parts of carbon black. For the same reason, the total quantity of solvent relative to carbon black is desirably 100 to 1,000 weight parts per 100 weight parts of carbon black in the carbon black composition of the present invention.

The essential solvent in the carbon black composition of the present invention is selected from the group consisting of methyl ethyl ketone, cyclohexanone, isophorone, and ethanol. When employing a solvent that is not a member of the essential solvent, it is desirable to cover the surface of the carbon black with the organic tertiary amine by mixing the carbon black and organic tertiary amine in the above essential solvent in advance. Thus, the carbon black dispersion will be well maintained when the other solvent is added.

As set forth above, the essential solvent in the carbon black composition of the present invention is selected from the group consisting of methyl ethyl ketone, cyclohexanone, isophorone, and ethanol. From the perspective of the carbon black dispersion-enhancing effect, it is desirable to incorporate at least methyl ethyl ketone and/or cyclohexanone. A single solvent can be employed alone, or two or more of these solvents can be combined in any ratio for use as the essential solvent. Methyl ethyl ketone, cyclohexanone, isophorone, and ethanol are all readily available. They are thus organic solvents that are widely employed in various fields, such as magnetic recording, printing, and cosmetics. Since the carbon black composition of the present invention contains an essential solvent in the form of the above solvents, it is highly useful in all of these fields. That is one advantage afforded by the carbon black composition of the present invention. Methyl ethyl ketone, cyclohexanone, and ethanol all have relatively low boiling points, are highly safe, and are easy to handle. From that perspective, methyl ethyl ketone, cyclohexanone, and ethanol are desirable.

The carbon black composition of the present invention can contain solvents other than the above essential solvent. In that case, the essential solvent desirably accounts for equal to or more than 50 weight %, preferably 50 to 95 weight %, of the total quantity of solvent. Examples of solvents that can be additionally employed are ether solvents, ester solvents, and ketone solvents. Specific examples of ketone solvents that can be additionally employed are acetone, methyl isobutyl ketone, and diisobutyl ketone. However, aromatic solvents such as benzene, toluene, and xylene potentially promote the formation of carbon black structures, so the additional use thereof is undesirable. When additionally employed, they are desirably kept to less than 5 weight % of the total quantity of solvent.

One known common method of raising the dispersion of microparticles is the method of covering the surface of the microparticles with binder resin. However, in the carbon black composition of the present invention, by combining the above-described essential solvent and the organic tertiary amine, a high state of carbon black dispersion can be achieved without combining the use of a binder resin. Specifically, even when the carbon black composition of the present invention does not contain a binder resin, a state of high dispersion of carbon black with a particle diameter in liquid as measured by the dynamic light scattering method, for example, of equal to or less than 150 nm, desirably equal to or less than 70 nm, and preferably, equal to or less than 50 nm, can be achieved.

In this context, the term “particle diameter in liquid as measured by the dynamic light scattering method” is an index of the state in which the carbon black is present in the carbon black composition of the present invention, that is, the state of dispersion. The lower the value, the better the state of dispersion in a state approximating primary particles without the carbon black undergoing aggregation that is achieved. Measurement by the dynamic light scattering method can be conducted with an LB-500 dynamic light scattering particle size analyzer made by Horiba. The particle diameter in liquid can also be measured by dilution with the liquid that is to be measured to enhance measurement precision. In that case, to further enhance measurement precision, it is desirable to employ a solvent that is contained in the liquid that is to be measured as the diluting solvent, and preferable to use the same solvent as the liquid to be measured.

The carbon black can be dispersed to an even higher degree by incorporating a binder resin into the carbon black composition of the present invention. By combining a binder resin, the carbon black can be dispersed to an extremely high state of dispersion of a particle diameter in liquid of equal to or less than 50 nm, even equal to or less than 40 nm. Regardless of whether or not a binder resin is employed, the lower limit of the particle diameter in liquid is the primary particle diameter or average primarily particle diameter of the carbon black.

Examples of binder resins that can be employed are polyurethane resin, polyester resin, polyamide resin, vinyl chloride resin, acrylic resins obtained by copolymerizing styrene, acrylonitrile, methyl methacrylate, or the like, cellulose resins such as nitrocellulose, epoxy resin, phenoxy resin, and polyvinyl alkyral resins such as polyvinyl acetal and polyvinyl butyral. Of these, vinyl copolymers and polyurethane resins are employed with preference. The binder resin can be employed in a proportion of 1 to 100 weight parts per 100 weight parts of carbon black, for example.

The average particle size of powders such as carbon black in the present invention can be measured by the following method.

Particles of powder are photographed at a magnification of 100,000-fold with a model H-9000 transmission electron microscope made by Hitachi and printed on photographic paper at a total magnification of 500,000-fold to obtain particle photographs. The targeted particle is selected from the particle photographs, the contours of the particle are traced with a digitizer, and the size of the particles is measured with KS-400 image analyzer software from Carl Zeiss. The size of 500 particles is measured. The average value of the particle sizes measured by the above method is adopted as an average particle size of the powder.

The size of a powder (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method. As in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

The average powder size of the powder is the arithmetic average of the above powder size and is calculated by measuring five hundred primary particles in the above-described method. The term “primary particle” refers to a nonaggregated, independent particle.

The carbon black composition of the present invention can be prepared by simultaneously or sequentially mixing the above-described essential solvent, organic tertiary amine, and carbon black. To further enhance carbon black dispersion, solvents other than the essential solvent and optional components such as various additives that are selected for use based on the application of the carbon black composition of the present invention are desirably added after mixing the above essential components.

The carbon black composition of the present invention as set forth above is suitable for use in various fields in which a high degree of carbon black dispersion is demanded, such as in particulate magnetic recording media, print ink, paint, cosmetics, and batteries.

The present invention further relates to a carbon black-containing coating film, which has been obtained by drying the carbon black composition of the present invention.

The carbon black composition of the present invention that is set forth above can contain carbon black in a highly dispersed state. Thus, a coating film affording good surface smoothness without surface roughening due to aggregation of carbon black can be obtained by coating and drying the composition on a support, for example. One embodiment of the coating film of the present invention can be employed in various modes such as antistatic sheets, and is not limited to the backcoat layer, nonmagnetic layer, magnetic layer, or the like of magnetic recording media.

The present invention further relates to a magnetic recording medium comprising a magnetic layer containing a ferromagnetic powder and a binder on a nonmagnetic support, which comprises a carbon black-containing coating film obtained by drying the carbon black composition of the present invention set forth above. The carbon black-containing coating film that is comprised in the magnetic recording medium of the present invention normally contains binder. The details of the binder as set forth above.

In one embodiment, the carbon black-containing coating film can be a nonmagnetic layer positioned between the nonmagnetic support and the magnetic layer. In another embodiment, the carbon black-containing coating film can be a backcoat layer positioned on the opposite surface of the nonmagnetic support from the surface on which the magnetic layer is present. In still another embodiment, the carbon black-containing coating film can be a magnetic layer. The details of the carbon black contained in the nonmagnetic layer, backcoat layer, and magnetic layer are as set forth above.

The nonmagnetic layer of a particulate magnetic recording medium comprises a nonmagnetic powder and a binder. When the carbon black-containing coating film is the nonmagnetic layer of a particulate magnetic recording medium, the total quantity of nonmagnetic powder that is contained in the nonmagnetic layer can be comprised of carbon black, or can be comprised of carbon black and some other nonmagnetic powder.

In the layer structure of the magnetic recording medium of the present invention, the thickness of the nonmagnetic support is desirably 3 to 80 μm. The thickness of the magnetic layer is optimized based on the saturation magnetization level and head gap length of the magnetic head employed and the bandwidth of the recording signal. From the perspective of achieving a high capacity, the thickness of the magnetic layer is desirably 10 to 100 nm, preferably 20 to 80 nm. It suffices to have at least one magnetic layer, and it does not matter if the magnetic layer is separated into two or more layers having different magnetic properties; known configurations for multilayered magnetic layers can be applied. The thickness of the nonmagnetic layer is desirably 0.6 to 3.0 μm, preferably 0.6 to 2.5 μm, and more preferably, 0.6 to 2.0 μm. The thickness of the backcoat layer is desirably equal to or less than 0.9 μm, preferably 0.1 to 0.7 μm.

When the magnetic recording medium of the present invention has a nonmagnetic layer, the nonmagnetic layer will produce its effect so long as it is essentially nonmagnetic. The effect of the present invention will be achieved even if impurities or small quantities of magnetic material are intentionally incorporated into the nonmagnetic layer, and such configurations can be viewed as being essentially identical to the magnetic recording medium of the present invention. The term “essentially identical” means that the residual flux density of the nonmagnetic layer is equal to or less than 10 mT (100 G) and the coercivity is equal to or less than 7.96 kA/m (100 Oe), and desirably means that no residual flux density or coercivity is present.

Known techniques relating to magnetic recording media, including the techniques described in above-cited references can be applied without limitation to the magnetic recording medium of the present invention, with the single exception that at least one layer is the carbon black-containing coating film set forth above.

### EXAMPLES

The present invention will be described in detail below based on Examples. However, the present invention is not limited to the examples.

### 1. Examples and Comparative Examples of Carbon Black Composition Containing No Binder Resin

### Example 1

In 20 weight parts of ethanol were suspended 1.0 weight part of the following carbon black and 0.019 weight part of triethylamine. To this suspension were added 50 weight parts of zirconia beads (made by Nikkato) 0.1 mm in diameter and the mixture was dispersed for 15 hours to obtain a carbon dispersion.

The diameter of the dispersed particles measured by the following method (the diameter of the particles in liquid as measured by the dynamic light scattering method) was 44 nm.

Carbon black: #950, made by Mitsubishi Chemical Corp.

Average primary particle diameter: 18 nm

Nitrogen adsorption specific surface area: 260 m²/g

DBP oil absorption capacity: 79 mL/100 g (powder form)

pH: 7.5

Method of Measuring Dispersed Particle Diameter (Particle Diameter in Liquid by Dynamic Light Scattering Method)

The carbon dispersion was diluted with the same organic solvent as that employed in dispersion to a solid component concentration of 0.2 weight % (the solid component denoted the combined weight of the carbon black, amine additive, and binder resin. Thus, for the system containing no binder resin, the solid component denoted the combined weight of the carbon black and amine additive).

The average particle diameter as measured with an LB-500 dynamic light scattering particle size analyzer made by Horiba for the diluted liquid obtained was adopted as the dispersed particle diameter. The smaller the dispersed particle diameter, the better the dispersion without aggregation of carbon black indicated.

### Example 2

With the exception that the 0.019 weight part of triethylamine was replaced with 0.024 weight part of N,N-diisopropylethylamine, a carbon dispersion was obtained by the same operation as in Example 1. The diameter of the dispersed particles was 45 nm as measured by the above method.

### Example 3

With the exception that the 0.019 weight part of triethylamine was replaced with 0.027 weight part of tripropylamine, a carbon dispersion was obtained by the same operation as in Example 1. The diameter of the dispersed particles was 45 nm as measured by the above method.

### Example 4

With the exception that the 0.019 weight part of triethylamine was replaced with 0.035 weight part of tributylamine, a carbon dispersion was obtained by the same operation as in Example 1. The diameter of the dispersed particles was 44 nm as measured by the above method.

### Example 5

With the exception that the 0.019 weight part of triethylamine was replaced with 0.043 weight part of triamylamine, a carbon dispersion was obtained by the same operation as in Example 1. The diameter of the dispersed particles was 41 nm as measured by the above method.

### Example 6

With the exception that the 0.019 weight part of triethylamine was replaced with 0.051 weight part of trihexylamine, a carbon dispersion was obtained by the same operation as in Example 1. The diameter of the dispersed particles was 43 nm as measured by the above method.

### Example 7

With the exception that the 0.019 weight part of triethylamine was replaced with 0.059 weight part of triheptylamine, a carbon dispersion was obtained by the same operation as in Example 1. The diameter of the dispersed particles was 51 nm as measured by the above method.

### Example 8

With the exception that the 0.019 weight part of triethylamine was replaced with 0.066 weight part of trioctylamine, a carbon dispersion was obtained by the same operation as in Example 1. The diameter of the dispersed particles was 62 nm as measured by the above method.

### Comparative Example 1

With the exception that the 20 weight parts of ethanol were replaced with 20 weight parts of acetone, a carbon dispersion was obtained by the same operation as in Example 1. The diameter of the dispersed particles was 120 nm as measured by the above method.

### Comparative Example 2

With the exception that the 20 weight parts of ethanol were replaced with 20 weight parts of acetone, a carbon dispersion was obtained by the same operation as in Example 2. The diameter of the dispersed particles was 96 nm as measured by the above method.

### Comparative Example 3

With the exception that the 20 weight parts of ethanol were replaced with 20 weight parts of acetone, a carbon dispersion was obtained by the same operation as in Example 3. The diameter of the dispersed particles was 100 nm as measured by the above method.

### Comparative Example 4

With the exception that the 20 weight parts of ethanol were replaced with 20 weight parts of acetone, a carbon dispersion was obtained by the same operation as in Example 4. The diameter of the dispersed particles was 98 nm as measured by the above method.

### Comparative Example 5

With the exception that the 20 weight parts of ethanol were replaced with 20 weight parts of isopropyl alcohol, a carbon dispersion was obtained by the same operation as in Example 4. The diameter of the dispersed particles was 108 nm as measured by the above method.

### Comparative Example 6

With the exception that the 20 weight parts of ethanol were replaced with 20 weight parts of 2-butanol, a carbon dispersion was obtained by the same operation as in Example 4. The diameter of the dispersed particles was 140 nm as measured by the above method.

### Comparative Example 7

With the exception that the 20 weight parts of ethanol were replaced with 20 weight parts of acetone, a carbon dispersion was obtained by the same operation as in Example 5. The diameter of the dispersed particles was 94 nm as measured by the above method.

### Comparative Example 8

With the exception that the 20 weight parts of ethanol were replaced with 20 weight parts of acetone, a carbon dispersion was obtained by the same operation as in Example 6. The diameter of the dispersed particles was 105 nm as measured by the above method.

### Comparative Example 9

With the exception that the 20 weight parts of ethanol were replaced with 20 weight parts of acetone, a carbon dispersion was obtained by the same operation as in Example 7. The diameter of the dispersed particles was 100 nm as measured by the above method.

### Comparative Example 10

With the exception that the 20 weight parts of ethanol were replaced with 20 weight parts of acetone, a carbon dispersion was obtained by the same operation as in Example 8. The diameter of the dispersed particles was 125 nm as measured by the above method.

### Example 9

With the exception that the 20 weight parts of ethanol were replaced with 20 weight parts of methyl ethyl ketone, a carbon dispersion was obtained by the same operation as in Example 1. The diameter of the dispersed particles was 35 nm as measured by the above method.

### Example 10

With the exception that the 20 weight parts of ethanol were replaced with 20 weight parts of methyl ethyl ketone, a carbon dispersion was obtained by the same operation as in Example 2. The diameter of the dispersed particles was 35 nm as measured by the above method.

### Example 11

With the exception that the 20 weight parts of ethanol were replaced with 20 weight parts of methyl ethyl ketone, a carbon dispersion was obtained by the same operation as in Example 3. The diameter of the dispersed particles was 34 nm as measured by the above method.

### Example 12

With the exception that the 20 weight parts of ethanol were replaced with 20 weight parts of methyl ethyl ketone, a carbon dispersion was obtained by the same operation as in Example 4. The diameter of the dispersed particles was 34 nm as measured by the above method.

### Example 13

With the exception that the 20 weight parts of ethanol were replaced with 20 weight parts of methyl ethyl ketone, a carbon dispersion was obtained by the same operation as in Example 5. The diameter of the dispersed particles was 31 nm as measured by the above method.

### Example 14

With the exception that the 20 weight parts of ethanol were replaced with 20 weight parts of methyl ethyl ketone, a carbon dispersion was obtained by the same operation as in Example 6. The diameter of the dispersed particles was 31 nm as measured by the above method.

### Example 15

With the exception that the 20 weight parts of ethanol were replaced with 20 weight parts of methyl ethyl ketone, a carbon dispersion was obtained by the same operation as in Example 7. The diameter of the dispersed particles was 31 nm as measured by the above method.

### Example 16

With the exception that the 20 weight parts of ethanol were replaced with 20 weight parts of methyl ethyl ketone, a carbon dispersion was obtained by the same operation as in Example 8. The diameter of the dispersed particles was 31 nm as measured by the above method.

### Example 17

With the exception that the 20 weight parts of ethanol were replaced with 20 weight parts of cyclohexanone, a carbon dispersion was obtained by the same operation as in Example 1. The diameter of the dispersed particles was 35 nm as measured by the above method.

### Example 18

With the exception that the 20 weight parts of ethanol were replaced with 20 weight parts of cyclohexanone, a carbon dispersion was obtained by the same operation as in Example 2. The diameter of the dispersed particles was 34 nm as measured by the above method.

### Example 19

With the exception that the 20 weight parts of ethanol were replaced with 20 weight parts of cyclohexanone, a carbon dispersion was obtained by the same operation as in Example 3. The diameter of the dispersed particles was 35 nm as measured by the above method.

### Example 20

With the exception that the 20 weight parts of ethanol were replaced with 20 weight parts of cyclohexanone, a carbon dispersion was obtained by the same operation as in Example 4. The diameter of the dispersed particles was 34 nm as measured by the above method.

### Example 21

With the exception that the 20 weight parts of ethanol were replaced with 20 weight parts of cyclohexanone, a carbon dispersion was obtained by the same operation as in Example 5. The diameter of the dispersed particles was 31 nm as measured by the above method.

### Example 22

With the exception that the 20 weight parts of ethanol were replaced with 20 weight parts of cyclohexanone, a carbon dispersion was obtained by the same operation as in Example 6. The diameter of the dispersed particles was 29 nm as measured by the above method.

### Example 23

With the exception that the 20 weight parts of ethanol were replaced with 20 weight parts of cyclohexanone, a carbon dispersion was obtained by the same operation as in Example 7. The diameter of the dispersed particles was 30 nm as measured by the above method.

### Example 24

With the exception that the 20 weight parts of ethanol were replaced with 20 weight parts of cyclohexanone, a carbon dispersion was obtained by the same operation as in Example 8. The diameter of the dispersed particles was 30 nm as measured by the above method.

### Example 25

With the exception that the 20 weight parts of ethanol were replaced with 10 weight parts of methyl ethyl ketone and 10 weight parts of cyclohexanone, a carbon dispersion was obtained by the same operation as in Example 1. The diameter of the dispersed particles was 31 nm as measured by the above method.

### Example 26

With the exception that the 20 weight parts of ethanol were replaced with 10 weight parts of methyl ethyl ketone and 10 weight parts of cyclohexanone, a carbon dispersion was obtained by the same operation as in Example 2. The diameter of the dispersed particles was 29 nm as measured by the above method.

### Example 27

With the exception that the 20 weight parts of ethanol were replaced with 10 weight parts of methyl ethyl ketone and 10 weight parts of cyclohexanone, a carbon dispersion was obtained by the same operation as in Example 3. The diameter of the dispersed particles was 32 nm as measured by the above method.

### Example 28

With the exception that the 20 weight parts of ethanol were replaced with 10 weight parts of methyl ethyl ketone and 10 weight parts of cyclohexanone, a carbon dispersion was obtained by the same operation as in Example 4. The diameter of the dispersed particles was 31 nm as measured by the above method.

### Example 29

With the exception that the 20 weight parts of ethanol were replaced with 10 weight parts of methyl ethyl ketone and 10 weight parts of cyclohexanone, a carbon dispersion was obtained by the same operation as in Example 5. The diameter of the dispersed particles was 30 nm as measured by the above method.

### Example 30

With the exception that the 20 weight parts of ethanol were replaced with 10 weight parts of methyl ethyl ketone and 10 weight parts of cyclohexanone, a carbon dispersion was obtained by the same operation as in Example 6. The diameter of the dispersed particles was 32 nm as measured by the above method.

### Example 31

With the exception that the 20 weight parts of ethanol were replaced with 10 weight parts of methyl ethyl ketone and 10 weight parts of cyclohexanone, a carbon dispersion was obtained by the same operation as in Example 7. The diameter of the dispersed particles was 29 nm as measured by the above method.

### Example 32

With the exception that the 20 weight parts of ethanol were replaced with 10 weight parts of methyl ethyl ketone and 10 weight parts of cyclohexanone, a carbon dispersion was obtained by the same operation as in Example 8. The diameter of the dispersed particles was 30 nm as measured by the above method.

### Comparative Example 11

In 20 weight parts of toluene were suspended 1.0 weight part of carbon black employed in Example land 0.019 weight part of the triethylamine. To the suspension were added 50 weight parts of zirconia beads 0.1 mm in diameter (made by Nikkato). The mixture was dispersed for 15 hours to obtain a carbon dispersion. The diameter of the dispersed particles exceeded 2,000 nm as measured by the above method, indicating that they were contained as an aggregated precipitate.

### Comparative Example 12

With the exception that the 0.019 weight part of triethylamine was replaced with 0.024 weight part of N,N-diisopropylethylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 13

With the exception that the 0.019 weight part of triethylamine was replaced with 0.027 weight part of tripropylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 14

With the exception that the 0.019 weight part of triethylamine was replaced with 0.035 weight part of tributylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 15

With the exception that the 0.019 weight part of triethylamine was replaced with 0.043 weight part of triamylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 16

With the exception that the 0.019 weight part of triethylamine was replaced with 0.051 weight part of trihexylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 17

With the exception that the 0.019 weight part of triethylamine was replaced with 0.059 weight part of triheptylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 18

With the exception that the 0.019 weight part of triethylamine was replaced with 0.066 weight part of trioctylamine, a carbon dispersion was obtained in the same manner as in Comparative Example 11. The diameter of the dispersed particles exceeded 2,000 nm as measured by the above method, indicating that they were contained as an aggregated precipitate.

### Comparative Example 19

With the exception that the 20 weight parts of toluene were replaced with 20 weight parts of ethyl acetate, a carbon dispersion was obtained by the same operation as in Comparative Example 11. The diameter of the dispersed particles exceeded 2,000 nm as measured by the above method, indicating that they were contained as an aggregated precipitate.

### Comparative Example 20

With the exception that the 20 weight parts of toluene were replaced with 20 weight parts of ethyl acetate, a carbon dispersion was obtained by the same operation as in Comparative Example 12. The diameter of the dispersed particles exceeded 2,000 nm as measured by the above method, indicating that they were contained as an aggregated precipitate.

### Comparative Example 21

With the exception that the 20 weight parts of toluene were replaced with 20 weight parts of ethyl acetate, a carbon dispersion was obtained by the same operation as in Comparative Example 13. The diameter of the dispersed particles exceeded 2,000 nm as measured by the above method, indicating that they were contained as an aggregated precipitate.

### Comparative Example 22

With the exception that the 20 weight parts of toluene were replaced with 20 weight parts of ethyl acetate, a carbon dispersion was obtained by the same operation as in Comparative Example 14. The diameter of the dispersed particles exceeded 2,000 nm as measured by the above method, indicating that they were contained as an aggregated precipitate.

### Comparative Example 23

With the exception that the 20 weight parts of toluene were replaced with 20 weight parts of ethyl acetate, a carbon dispersion was obtained by the same operation as in Comparative Example 15. The diameter of the dispersed particles exceeded 2,000 nm as measured by the above method, indicating that they were contained as an aggregated precipitate.

### Comparative Example 24

With the exception that the 20 weight parts of toluene were replaced with 20 weight parts of ethyl acetate, a carbon dispersion was obtained by the same operation as in Comparative Example 16. The diameter of the dispersed particles exceeded 2,000 nm as measured by the above method, indicating that they were contained as an aggregated precipitate.

### Comparative Example 25

With the exception that the 20 weight parts of toluene were replaced with 20 weight parts of ethyl acetate, a carbon dispersion was obtained by the same operation as in Comparative Example 17. The diameter of the dispersed particles exceeded 2,000 nm as measured by the above method, indicating that they were contained as an aggregated precipitate.

### Comparative Example 26

With the exception that the 20 weight parts of toluene were replaced with 20 weight parts of ethyl acetate, a carbon dispersion was obtained by the same operation as in Comparative Example 18. The diameter of the dispersed particles exceeded 2,000 nm as measured by the above method, indicating that they were contained as an aggregated precipitate.

### Comparative Example 27

With the exception that no triethylamine was employed, a carbon dispersion was obtained in the same manner as in Example 1. The diameter of the dispersed particles exceeded 2,000 nm as measured by the above method, indicating that they were contained as an aggregated precipitate.

### Comparative Example 28

With the exception that no triethylamine was employed, a carbon dispersion was obtained in the same manner as in Comparative Example 1. The diameter of the dispersed particles exceeded 2,000 nm as measured by the above method, indicating that they were contained as an aggregated precipitate.

### Comparative Example 29

With the exception that no triethylamine was employed, a carbon dispersion was obtained in the same manner as in Example 9. The diameter of the dispersed particles was 200 nm as measured by the above method.

### Comparative Example 30

With the exception that no triethylamine was employed, a carbon dispersion was obtained in the same manner as in Example 17 The diameter of the dispersed particles was 153 nm as measured by the above method.

The above results are given in Table 1.

TABLE 1

| | | | Dispersed | |
|---|---|---|---|---|
| | | | particle | Quantity of |
| | | | diameter | additive |
| | Additive | Solvent | (nm) | (weight part) |
| Ex. 1 | Triethylamine | Ethanol | 44 | 0.019 |
| Ex. 2 | N,N-diisopropylethylamine | Ethanol | 45 | 0.024 |
| Ex. 3 | Tripropylamine | Ethanol | 45 | 0.027 |
| Ex. 4 | Tributylamine | Ethanol | 44 | 0.035 |
| Ex. 5 | Triamylamine | Ethanol | 41 | 0.043 |
| Ex. 6 | Trihexylamine | Ethanol | 43 | 0.051 |
| Ex. 7 | Triheptylamine | Ethanol | 51 | 0.059 |
| Ex. 8 | Trioctylamine | Ethanol | 62 | 0.066 |
| Com. Ex. 1 | Triethylamine | Acetone | 120 | 0.019 |
| Com. Ex. 2 | N,N-diisopropylethylamine | Acetone | 96 | 0.024 |
| Com. Ex. 3 | Tripropylamine | Acetone | 100 | 0.027 |
| Com. Ex. 4 | Tributylamine | Acetone | 98 | 0.035 |
| Com. Ex. 5 | Tributylamine | Isopropyl alcohol | 108 | 0.035 |
| Com. Ex. 6 | Tributylamine | 2-butanol | 140 | 0.035 |
| Com. Ex. 7 | Triamylamine | Acetone | 94 | 0.043 |
| Com. Ex. 8 | Trihexylamine | Acetone | 105 | 0.051 |
| Com. Ex. 9 | Triheptylamine | Acetone | 100 | 0.059 |
| Com. Ex. 10 | Trioctylamine | Acetone | 125 | 0.066 |
| Ex. 9 | Triethylamine | Methyl ethyl ketone | 35 | 0.019 |
| Ex. 10 | N,N-diisopropylethylamine | Methyl ethyl ketone | 35 | 0.024 |
| Ex. 11 | Tripropylamine | Methyl ethyl ketone | 34 | 0.027 |
| Ex. 12 | Tributylamine | Methyl ethyl ketone | 34 | 0.035 |
| Ex. 13 | Triamylamine | Methyl ethyl ketone | 31 | 0.043 |
| Ex. 14 | Trihexylamine | Methyl ethyl ketone | 31 | 0.051 |
| Ex. 15 | Triheptylamine | Methyl ethyl ketone | 31 | 0.059 |
| Ex. 16 | Trioctylamine | Methyl ethyl ketone | 31 | 0.066 |
| Ex. 17 | Triethylamine | Cyclohexanone | 35 | 0.019 |
| Ex. 18 | N,N-diisopropylethylamine | Cyclohexanone | 34 | 0.024 |
| Ex. 19 | Tripropylamine | Cyclohexanone | 35 | 0.027 |
| Ex. 20 | Tributylamine | Cyclohexanone | 34 | 0.035 |
| Ex. 21 | Triamylamine | Cyclohexanone | 31 | 0.043 |
| Ex. 22 | Trihexylamine | Cyclohexanone | 29 | 0.051 |
| Ex. 23 | Triheptylamine | Cyclohexanone | 30 | 0.059 |
| Ex. 24 | Trioctylamine | Cyclohexanone | 30 | 0.066 |
| Ex. 25 | Triethylamine | Methyl ethyl ketone, cyclohexanone | 31 | 0.019 |
| Ex. 26 | N,N-diisopropylethylamine | Methyl ethyl ketone, cyclohexanone | 29 | 0.024 |
| Ex. 27 | Tripropylamine | Methyl ethyl ketone, cyclohexanone | 32 | 0.027 |
| Ex. 28 | Tributylamine | Methyl ethyl ketone, cyclohexanone | 31 | 0.035 |
| Ex. 29 | Triamylamine | Methyl ethyl ketone, cyclohexanone | 30 | 0.043 |
| Ex. 30 | Trihexylamine | Methyl ethyl ketone, cyclohexanone | 32 | 0.051 |
| Ex. 31 | Triheptylamine | Methyl ethyl ketone, cyclohexanone | 29 | 0.059 |
| Ex. 32 | Trioctylamine | Methyl ethyl ketone, cyclohexanone | 30 | 0.066 |
| Com. Ex. 11 | Triethylamine | Toluene | >2000 | 0.019 |
| Com. Ex. 12 | N,N-diisopropylethylamine | Toluene | >2000 | 0.024 |
| Com. Ex. 13 | Tripropylamine | Toluene | >2000 | 0.027 |
| Com. Ex. 14 | Tributylamine | Toluene | >2000 | 0.035 |
| Com. Ex. 15 | Triamylamine | Toluene | >2000 | 0.043 |
| Com. Ex. 16 | Trihexylamine | Toluene | >2000 | 0.051 |
| Com. Ex. 17 | Triheptylamine | Toluene | >2000 | 0.059 |
| Com. Ex. 18 | Trioctylamine | Toluene | >2000 | 0.066 |
| Com. Ex. 19 | Triethylamine | Ethyl acetate | >2000 | 0.019 |
| Com. Ex. 20 | N,N-diisopropylethylamine | Ethyl acetate | >2000 | 0.024 |
| Com. Ex. 21 | Tripropylamine | Ethyl acetate | >2000 | 0.027 |
| Com. Ex. 22 | Tributylamine | Ethyl acetate | >2000 | 0.035 |
| Com. Ex. 23 | Triamylamine | Ethyl acetate | >2000 | 0.043 |
| Com. Ex. 24 | Trihexylamine | Ethyl acetate | >2000 | 0.051 |
| Com. Ex. 25 | Triheptylamine | Ethyl acetate | >2000 | 0.059 |
| Com. Ex. 26 | Trioctylamine | Ethyl acetate | >2000 | 0.066 |
| Com. Ex. 27 | None | Ethanol | >2000 | 0 |
| Com. Ex. 28 | None | Acetone | >2000 | 0 |
| Com. Ex. 29 | None | Methyl ethyl ketone | 200 | 0 |
| Com. Ex. 30 | None | Cyclohexanone | 153 | 0 |

### 2. Examples and Comparative Examples of the Binder Resin-Containing Carbon Black Composition and Coating Film

### Example 33

In a solution comprised of 12 weight parts of methyl ethyl ketone and 8 weight parts of cyclohexanone were suspended 1.0 weight part of the carbon black employed in Example 1, 0.019 weight part of triethylamine, 0.41 weight part of vinyl chloride resin (MR104 made by Zeon Corp.), and 0.25 weight part of polyether polyurethane. To the dispersion were then added 50 weight parts of zirconia beads 0.1 mm in diameter (made by Nikkato) and the mixture was dispersed for 15 hours, yielding a carbon dispersion. The diameter of the dispersed particles was 25 nm as measured by the above method.

A coating film was prepared by coating the above carbon dispersion on a PEN base made by Teijin using a doctor blade with a 19 μm gap. The coating film was left standing for 30 minutes at room temperature to dry. The average roughness of the coating film prepared was 1.6 nm as measured by the method set forth further below.

Method of Surface Roughness Measurement

The surface roughness of the coating film was measured at a scan length of 5 μm by scanning white light interferometry with a NewView 5022 general purpose 3D surface profile analyzer made by Zygo. The object lens was 20×, the intermediate lens was 1.0×, and the measurement viewfield was 260 μm×350 μm. The surface measured was processed with HPF: 1.65 μm and LPF: 50 μm filters to obtain the centerline average surface roughness Ra value.

### Example 34

With the exception that the 0.019 weight part of triethylamine was replaced with 0.024 weight part of N,N-diisopropylethylamine, a dispersion was obtained in accordance with Example 33. The diameter of the dispersed particles as measured by the above method was 26 nm. A coating film was prepared and the average roughness was measured by the above-described methods, revealing an average roughness of 1.6 nm.

### Example 35

With the exception that the 0.019 weight part of triethylamine was replaced with 0.027 weight part of tripropylamine, a dispersion was obtained in accordance with Example 33. The diameter of the dispersed particles as measured by the above method was 24 nm. A coating film was prepared and the average roughness was measured by the above-described methods, revealing an average roughness of 1.4 nm.

### Example 36

With the exception that the 0.019 weight part of triethylamine was replaced with 0.035 weight part of tributylamine, a dispersion was obtained in accordance with Example 33. The diameter of the dispersed particles as measured by the above method was 26 nm. A coating film was prepared and the average roughness was measured by the above-described methods, revealing an average roughness of 1.3 nm.

### Example 37

With the exception that the 0.019 weight part of triethylamine was replaced with 0.043 weight part of triamylamine, a dispersion was obtained in accordance with Example 33. The diameter of the dispersed particles as measured by the above method was 30 nm. A coating film was prepared and the average roughness was measured by the above-described methods, revealing an average roughness of 1.3 nm.

### Example 38

With the exception that the 0.019 weight part of triethylamine was replaced with 0.051 weight part of trihexylamine, a dispersion was obtained in accordance with Example 33. The diameter of the dispersed particles as measured by the above method was 26 nm. A coating film was prepared and the average roughness was measured by the above-described methods, revealing an average roughness of 1.3 nm.

### Example 39

With the exception that the 0.019 weight part of triethylamine was replaced with 0.059 weight part of triheptylamine, a dispersion was obtained in accordance with Example 33. The diameter of the dispersed particles as measured by the above method was 26 nm. A coating film was prepared and the average roughness was measured by the above-described methods, revealing an average roughness of 1.3 nm.

### Example 40

With the exception that the 0.019 weight part of triethylamine was replaced with 0.066 weight part of trioctylamine, a dispersion was obtained in accordance with Example 33. The diameter of the dispersed particles as measured by the above method was 26 nm. A coating film was prepared and the average roughness was measured by the above-described methods, revealing an average roughness of 1.3 nm.

### Example 41

With the exception that the 0.019 weight part of triethylamine was replaced with 0.029 weight part of 1,8-diazabicyclo[5.4.0]undeca-7-ene, a dispersion was obtained in accordance with Example 33. The diameter of the dispersed particles as measured by the above method was 30 nm. A coating film was prepared and the average roughness was measured by the above-described methods, revealing an average roughness of 1.8 nm.

### Example 42

With the exception that the 0.019 weight part of triethylamine was replaced with 0.025 weight part of N,N-dimethylbenzylamine, a dispersion was obtained in accordance with Example 33. The diameter of the dispersed particles as measured by the above method was 39 nm. A coating film was prepared and the average roughness was measured by the above-described methods, revealing an average roughness of 2.5 nm.

### Example 43

With the exception that the 0.019 weight part of triethylamine was replaced with 0.030 weight part of N-butyldiethanolamine, a dispersion was obtained in accordance with Example 33. The diameter of the dispersed particles as measured by the above method was 39 nm. A coating film was prepared and the average roughness was measured by the above-described methods, revealing an average roughness of 1.6 nm.

### Example 44

With the exception that the 0.019 weight part of triethylamine was replaced with 0.026 weight part of hexamethylenetetraamine, a dispersion was obtained in accordance with Example 33. The diameter of the dispersed particles as measured by the above method was 39 nm. A coating film was prepared and the average roughness was measured by the above-described methods, revealing an average roughness of 1.6 nm.

### Example 45

With the exception that the 0.019 weight part of triethylamine was replaced with 0.038 weight part of triethylamine, a dispersion was obtained in accordance with Example 33. The diameter of the dispersed particles as measured by the above method was 25 nm. A coating film was prepared and the average roughness was measured by the above-described methods, revealing an average roughness of 1.6 nm.

### Example 46

With the exception that the 0.019 weight part of triethylamine was replaced with 0.076 weight part of triethylamine, a dispersion was obtained in accordance with Example 33. The diameter of the dispersed particles as measured by the above method was 25 nm. A coating film was prepared and the average roughness was measured by the above-described methods, revealing an average roughness of 1.6 nm.

### Example 47

With the exceptions that the 12 weight parts of methyl ethyl ketone and the 8 weight parts of cyclohexanone were replaced with 20 weight parts of isophorone and the 0.019 weight part of triethylamine was replaced with 0.066 weight part of trioctylamine, a dispersion was obtained in accordance with Example 33. The diameter of the dispersed particles as measured by the above method was 30 nm. A coating film was prepared and the average roughness was measured by the above-described methods, revealing an average roughness of 3.1 nm.

### Comparative Example 31

With the exception that the 0.019 weight part of triethylamine was replaced with 0.015 weight part of pyridine, a dispersion was obtained in accordance with Example 33. The diameter of the dispersed particles as measured by the above method was 170 nm. A coating film was prepared and the average roughness was measured by the above-described methods, revealing an average roughness exceeding 10 nm.

### Comparative Example 32

With the exception that the 0.019 weight part of triethylamine was replaced with 0.017 weight part of α-picoline, a dispersion was obtained in accordance with Example 33. The diameter of the dispersed particles as measured by the above method was 168 nm. A coating film was prepared and the average roughness was measured by the above-described methods, revealing an average roughness exceeding 10 nm.

### Comparative Example 33

With the exception that the 0.019 weight part of triethylamine was replaced with 0.017 weight part of β-picoline, a dispersion was obtained in accordance with Example 33. The diameter of the dispersed particles as measured by the above method was 188 nm. A coating film was prepared and the average roughness was measured by the above-described methods, revealing an average roughness exceeding 10 nm.

### Comparative Example 34

With the exception that the 0.019 weight part of triethylamine was replaced with 0.017 weight part of γ-picoline, a dispersion was obtained in accordance with Example 33. The diameter of the dispersed particles as measured by the above method was 143 nm. A coating film was prepared and the average roughness was measured by the above-described methods, revealing an average roughness exceeding 10 nm.

### Comparative Example 35

With the exception that the 0.019 weight part of triethylamine was replaced with 0.023 weight part of N,N-dimethylaniline, a dispersion was obtained in accordance with Example 33. The diameter of the dispersed particles as measured by the above method was 160 nm. A coating film was prepared and the average roughness was measured by the above-described methods, revealing an average roughness exceeding 10 nm.

### Comparative Example 36

With the exception that the 0.019 weight part of triethylamine was replaced with 0.034 weight part of N-phenyldiethanolamine, a dispersion was obtained in accordance with Example 33. The diameter of the dispersed particles as measured by the above method was 84 nm. A coating film was prepared and the average roughness was measured by the above-described methods, revealing an average roughness exceeding 10 nm.

### Comparative Example 37

With the exception that the 0.019 weight part of triethylamine was replaced with 0.017 weight part of aniline, a dispersion was obtained in accordance with Example 33. The diameter of the dispersed particles as measured by the above method was 52 nm. A coating film was prepared and the average roughness was measured by the above-described methods, revealing an average roughness exceeding 3.4 nm.

### Comparative Example 38

With the exception that the 0.019 weight part of triethylamine was replaced with 0.024 weight part of dibutylamine, a dispersion was obtained in accordance with Example 33. The diameter of the dispersed particles as measured by the above method was 80 nm. A coating film was prepared and the average roughness was measured by the above-described methods, revealing an average roughness exceeding 10 nm.

### Comparative Example 39

With the exception that no triethylamine was employed, a carbon dispersion was obtained by the same operation as in Example 33. The diameter of the dispersed particles as measured by the above method was 140 nm. A coating film was prepared and the average roughness was measured by the above-described methods, revealing an average roughness exceeding 10 nm.

### Comparative Example 40

With the exceptions that the 12 weight parts of methyl ethyl ketone and the 8 weight parts of cyclohexanone were replaced with 20 weight parts of 4-methyl-2-pentanone, and the 0.019 weight part of triethylamine was replaced with 0.066 weight part of trioctylamine, a carbon dispersion was obtained by the same operation as in Example 33. The carbon dispersion obtained was unstable. An attempt was made to measure the diameter of the dispersed particles by the method set forth above, but measurement was precluded by a precipitate that formed prior to measurement. A coating film was prepared and the average roughness was measured by the above-described methods, revealing an average roughness exceeding 16 nm.

### Comparative Example 41

With the exceptions that the 12 weight parts of methyl ethyl ketone and the 8 weight parts of cyclohexanone were replaced with 20 weight parts of 2,4-dimethyl-3-pentanone, and the 0.019 weight part of triethylamine was replaced with 0.066 weight part of trioctylamine, a carbon dispersion was obtained by the same operation as in Example 33. The carbon dispersion obtained was unstable. An attempt was made to measure the diameter of the dispersed particles by the method set forth above, but measurement was precluded by a precipitate that formed prior to measurement. An attempt was made to form a coating film by the method set forth above, but the liquid was repelled and no coating film could be formed.

The above results are given in Table 2.

TABLE 2

| | | | Dispersed | | | Roughness |
|---|---|---|---|---|---|---|
| | | | particle | Quantity of | | of coating |
| | | | diameter | additive | | film |
| | Additive | Solvent | (nm) | (weight part) | Binder resin | (nm) |
| Ex. 33 | Triethylamine | Methyl ethyl ketone, cyclohexanone | 25 | 0.019 | Vinyl | 1.6 |
| | | | | | chloride | |
| | | | | | resin and | |
| | | | | | polyurethane | |
| Ex. 34 | N,N-diisopropylethylamine | Methyl ethyl ketone, cyclohexanone | 26 | 0.024 | Vinyl | 1.6 |
| | | | | | chloride | |
| | | | | | resin and | |
| | | | | | polyurethane | |
| Ex. 35 | Tripropylamine | Methyl ethyl ketone, cyclohexanone | 24 | 0.027 | Vinyl | 1.4 |
| | | | | | chloride | |
| | | | | | resin and | |
| | | | | | polyurethane | |
| Ex. 36 | Tributylamine | Methyl ethyl ketone, cyclohexanone | 26 | 0.035 | Vinyl | 1.3 |
| | | | | | chloride | |
| | | | | | resin and | |
| | | | | | polyurethane | |
| Ex. 37 | Triamylamine | Methyl ethyl ketone, cyclohexanone | 30 | 0.043 | Vinyl | 1.3 |
| | | | | | chloride | |
| | | | | | resin and | |
| | | | | | polyurethane | |
| Ex. 38 | Trihexylamine | Methyl ethyl ketone, cyclohexanone | 26 | 0.051 | Vinyl | 1.3 |
| | | | | | chloride | |
| | | | | | resin and | |
| | | | | | polyurethane | |
| Ex. 39 | Triheptylamine | Methyl ethyl ketone, cyclohexanone | 26 | 0.059 | Vinyl | 1.3 |
| | | | | | chloride | |
| | | | | | resin and | |
| | | | | | polyurethane | |
| Ex. 40 | Trioctylamine | Methyl ethyl ketone, cyclohexanone | 26 | 0.066 | Vinyl | 1.3 |
| | | | | | chloride | |
| | | | | | resin and | |
| | | | | | polyurethane | |
| Ex. 41 | 1,8-diazabicyclo[5.4.0]undeca- | Methyl ethyl ketone, cyclohexanone | 30 | 0.029 | Vinyl | 1.8 |
| | 7-ene | | | | chloride | |
| | | | | | resin and | |
| | | | | | polyurethane | |
| Ex. 42 | N,N-dimethylbenzylamine | Methyl ethyl ketone, cyclohexanone | 39 | 0.025 | Vinyl | 2.5 |
| | | | | | chloride | |
| | | | | | resin and | |
| | | | | | polyurethane | |
| Ex. 43 | N-butyldiethanolamine | Methyl ethyl ketone, cyclohexanone | 39 | 0.030 | Vinyl | 1.6 |
| | | | | | chloride | |
| | | | | | resin and | |
| | | | | | polyurethane | |
| Ex. 44 | Hexamethylenetetraamine | Methyl ethyl ketone, cyclohexanone | 39 | 0.026 | Vinyl | 1.6 |
| | | | | | chloride | |
| | | | | | resin and | |
| | | | | | polyurethane | |
| Ex. 45 | Triethylamine | Methyl ethyl ketone, cyclohexanone | 25 | 0.038 | Vinyl | 1.6 |
| | | | | | chloride | |
| | | | | | resin and | |
| | | | | | polyurethane | |
| Ex. 46 | Triethylamine | Methyl ethyl ketone, cyclohexanone | 25 | 0.076 | Vinyl | 1.6 |
| | | | | | chloride | |
| | | | | | resin and | |
| | | | | | polyurethane | |
| Ex. 47 | Trioctylamine | Isophorone | 30 | 0.066 | Vinyl | 3.1 |
| | | | | | chloride | |
| | | | | | resin and | |
| | | | | | polyurethane | |
| Com. Ex. 31 | Pyridine | Methyl ethyl ketone, cyclohexanone | 170 | 0.015 | Vinyl | >10 |
| | | | | | chloride | |
| | | | | | resin and | |
| | | | | | polyurethane | |
| Com. Ex. 32 | α-picoline | Methyl ethyl ketone, cyclohexanone | 168 | 0.017 | Vinyl | >10 |
| | | | | | chloride | |
| | | | | | resin and | |
| | | | | | polyurethane | |
| Com. Ex. 33 | β-picoline | Methyl ethyl ketone, cyclohexanone | 188 | 0.017 | Vinyl | >10 |
| | | | | | chloride | |
| | | | | | resin and | |
| | | | | | polyurethane | |
| Com. Ex. 34 | γ-picoline | Methyl ethyl ketone, cyclohexanone | 143 | 0.017 | Vinyl | >10 |
| | | | | | chloride | |
| | | | | | resin and | |
| | | | | | polyurethane | |
| Com. Ex. 35 | N,N-dimethylaniline | Methyl ethyl ketone, cyclohexanone | 160 | 0.023 | Vinyl | >10 |
| | | | | | chloride | |
| | | | | | resin and | |
| | | | | | polyurethane | |
| Com. Ex. 36 | N-phenyldiethanolamine | Methyl ethyl ketone, cyclohexanone | 84 | 0.034 | Vinyl | >10 |
| | | | | | chloride | |
| | | | | | resin and | |
| | | | | | polyurethane | |
| Com. Ex. 37 | Aniline | Methyl ethyl ketone, cyclohexanone | 52 | 0.017 | Vinyl | 3.4 |
| | | | | | chloride | |
| | | | | | resin and | |
| | | | | | polyurethane | |
| Com. Ex. 38 | Dibutylamine | Methyl ethyl ketone, cyclohexanone | 80 | 0.024 | Vinyl | >10 |
| | | | | | chloride | |
| | | | | | resin and | |
| | | | | | polyurethane | |
| Com. Ex. 39 | None | Methyl ethyl ketone, cyclohexanone | 140 | 0 | Vinyl | >10 |
| | | | | | chloride | |
| | | | | | resin and | |
| | | | | | polyurethane | |
| Com. Ex. 40 | Trioctylamine | 4-methyl-2-pentanone | — | 0.066 | Vinyl | 16 |
| | | | | | chloride | |
| | | | | | resin and | |
| | | | | | polyurethane | |
| Com. Ex. 41 | Trioctylamine | 2,4-dimethyl-3-pentanone | — | 0.066 | Vinyl | — |
| | | | | | chloride | |
| | | | | | resin and | |
| | | | | | polyurethane | |

The results shown in Tables 1 and 2 indicate that it was possible to disperse carbon black to a high degree by combining an organic tertiary amine selected from the group consisting of aliphatic tertiary monoamines and alicyclic tertiary amines and a solvent selected from the group consisting of methyl ethyl ketone, cyclohexanone, isophorone, and ethanol, and that a carbon black-containing coating film of high surface smoothness could be formed as a result.

### 3. Examples and Comparative Examples of Magnetic Recording Medium

The “parts” given below denote “weight parts.”

### Example 48

### Formula of Magnetic Layer Coating Composition

Ferromagnetic platelike hexagonal ferrite powder: 100 parts
Composition excluding oxygen: Ba/Fe/Co/Zn=1/9/0.2/1 (molar ratio)
Hc: 183 kA/m (2,300 Oe)
Plate diameter: 25 nm
Plate ratio: 3
Specific surface area by BET method: 80 m²/g
σs: 50 A·m²/kg (50 emu/g)

Polyurethane resin: 8 parts
(functional group: —SO₃Na, functional group concentration: 70 eq/t)

Vinyl chloride resin: 14 parts
(functional group: —OSO₃K, functional group concentration: 70 eq/t)

Oleic acid: 0.2 part

2,3-Dihydroxynaphthalene: 6 parts

α-Al₂O₃ (particle size: 0.15 μm): 5 parts

Carbon black (particle size: 100 nm): 2 parts

Cyclohexanone: 150 parts

Methyl ethyl ketone: 150 parts

Butyl stearate: 2 parts

Stearic acid: 1 part

Amide stearate: 0.1 part

Formula of Nonmagnetic Layer Coating Composition

Carbon black: 100 parts
DBP oil absorption capacity: 100 mL/100 g
pH: 8
Specific surface area by BET method: 250 m²/g
Volatile component: 1.5%

Polyurethane resin: 20 parts
(functional group: —SO₃Na, functional group concentration: 70 eq/t)

Vinyl chloride resin: 30 parts
(functional group: —OSO₃K, functional group concentration: 70 eq/t)

Triethylamine: 2 parts

Cyclohexanone: 140 parts

Methyl ethyl ketone: 170 parts

Butyl stearate: 2 parts

Stearic acid: 2 parts

Amide stearate: 0.1 part

The various components of the above magnetic layer coating composition and nonmagnetic layer coating composition were kneaded for 60 minutes in separate open kneaders and then dispersed for 720 minutes in separate sand mills using zirconia beads (0.5 mm in average diameter). Each of the dispersions was then filtered with a filter having an average pore diameter of 1 μm to prepare coating compositions for forming the various layers.

The nonmagnetic layer coating composition was coated in a quantity calculated to yield a dry thickness of 1.5 μm on a nonmagnetic support and dried at 100° C. The magnetic layer coating composition was applied wet-on-dry in a quantity calculated to yield a dry thickness of 0.08 μm immediately thereafter and dried at 100° C. The magnetic layer was then magnetically oriented with 300 mT (3,000 Gauss) magnets while not yet fully dry. A surface smoothing treatment was applied at 90° C. and a linear pressure of 300 kg/cm at a rate of 100 m/min with a seven-stage calender comprised solely of metal rolls, after which a heat curing treatment was conducted for 24 hours at 70° C. and the product was slit into a ½ inch width to prepare a magnetic tape.

The surface roughness of the magnetic layer of the magnetic tape obtained was 1.5 nm as measured by the above-described method.

### Example 49

With the exception that the 2 parts of triethylamine were replaced with 3.3 parts of tributylamine in the nonmagnetic layer coating composition, a magnetic tape was prepared and the surface roughness of the magnetic layer was measured by the same methods as in Example 48, revealing a surface roughness of 1.3 nm.

### Example 50

With the exception that the 2 parts of triethylamine were replaced with 6.3 parts of trioctylamine in the nonmagnetic layer coating composition, a magnetic tape was prepared and the surface roughness of the magnetic layer was measured by the same methods as in Example 48, revealing a surface roughness of 1.3 nm.

### Comparative Example 42

With the exception that the 2 parts of triethylamine of the nonmagnetic layer coating composition were replaced with 30 parts of phenylphosphonic acid, known as a dispersant in magnetic recording media, a magnetic tape was prepared and the surface roughness of the magnetic layer was measured by the same methods as in Example 48, revealing a surface roughness of 20 nm.

Since the surface smoothness of the magnetic layer greatly affects electromagnetic characteristics and running stability, the improved surface smoothness of the magnetic layer in Examples 48 to 50 greatly enhanced them relative to Comparative Example 42. That was because dispersion of the nonmagnetic powder (carbon black) was good in the nonmagnetic layer positioned beneath the magnetic layer.

Further, a backcoat layer can also be formed using the same formula as the nonmagnetic layer coating composition set forth above. The fact that carbon black would be well dispersed in a backcoat layer thus formed can also be determined based on the results of the above Examples.

The present invention is useful in various fields such as the magnetic recording field, print field, and cosmetic product field.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A carbon black composition, which comprises:
carbon black;
an organic tertiary amine selected from the group consisting of an aliphatic tertiary monoamine and an alicyclic tertiary amine; and
at least one organic solvent selected from the group consisting of methyl ethyl ketone, cyclohexanone, isophorone, and ethanol.

2. The carbon black composition according to claim 1, wherein the aliphatic tertiary monoamine is denoted by general formula (1): 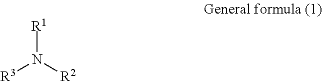
wherein each of R¹, R², and R³ independently denotes a linear or branched alkyl group having 1 to 18 carbon atoms.

3. The carbon black composition according to claim 2, wherein, in general formula (1), each of R¹, R², and R³ independently denotes a linear or branched alkyl group having 1 to 8 carbon atoms.

4. The carbon black composition according to claim 1, wherein the organic solvent comprises methyl ethyl ketone and/or cyclohexanone.

5. The carbon black composition according to claim 1, wherein the organic solvent comprises ethanol.

6. The carbon black composition according to claim 1, wherein the organic solvent comprises isophorone.

7. The carbon black composition according to claim 1, which comprises the carbon black in a dispersed state with a particle diameter in liquid as measured by a dynamic light scattering method of equal to or less than 70 nm with comprising no binder resin.

8. The carbon black composition according to claim 1, which further comprises a binder resin.

9. The carbon black composition according to claim 8, wherein the binder resin is selected from the group consisting of a vinyl copolymer and a polyurethane resin.

10. The carbon black composition according to claim 8, which comprises the carbon black in a dispersed state with a particle diameter in liquid as measured by a dynamic light scattering method of equal to or less than 50 nm.

11. The carbon black composition according to claim 1, which is employed as a coating composition for forming a magnetic recording medium or employed for preparation of a coating composition for forming a magnetic recording medium.

12. A carbon black-containing coating film, which has been obtained by drying a carbon black composition, the carbon black composition comprising:
carbon black;
an organic tertiary amine selected from the group consisting of an aliphatic tertiary monoamine and an alicyclic tertiary amine; and
at least one organic solvent selected from the group consisting of methyl ethyl ketone, cyclohexanone, isophorone, and ethanol.

13. A magnetic recording medium comprising a magnetic layer containing a ferromagnetic powder and a binder on a nonmagnetic support, which comprises a carbon black-containing coating film obtained by drying a carbon black composition, the carbon black composition comprising:
carbon black;
an organic tertiary amine selected from the group consisting of an aliphatic tertiary monoamine and an alicyclic tertiary amine; and
at least one organic solvent selected from the group consisting of methyl ethyl ketone, cyclohexanone, isophorone, and ethanol.

14. The magnetic recording medium according to claim 13, wherein the carbon black-containing coating film is a nonmagnetic layer positioned between the nonmagnetic support and the magnetic layer.

15. The magnetic recording medium according to claim 13, wherein the carbon black-containing coating film is a backcoat layer positioned on a surface of the nonmagnetic support opposite from a surface on which the magnetic layer is positioned.

16. The magnetic recording medium according to claim 13, wherein the aliphatic tertiary monoamine is denoted by general formula (1): 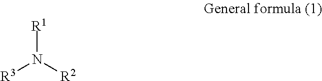
wherein each of R¹, R², and R³ independently denotes a linear or branched alkyl group having 1 to 18 carbon atoms.

17. The magnetic recording medium according to claim 16, wherein, in general formula (1), each of R¹, R², and R³ independently denotes a linear or branched alkyl group having 1 to 8 carbon atoms.

18. The magnetic recording medium according to claim 13, wherein the organic solvent comprises methyl ethyl ketone and/or cyclohexanone.

19. The magnetic recording medium according to claim 13, wherein the carbon black composition further comprises a binder resin.

20. The magnetic recording medium according to claim 19, wherein the binder resin is selected from the group consisting of a vinyl copolymer and a polyurethane resin.
